(19) United States
(12) Patent Application Publication
(10) Pub. No.: US 2020/0130235 A1
(43) Pub. Date: Apr. 30, 2020

(54) ENVIRONMENTALLY FRIENDLY FUEL MADE OF RUBBER AND MANUFACTURING METHOD THEREOF

(71) Applicant: YI-YI CHEN, TAINAN CITY (TW)

(72) Inventor: YI-YI CHEN, TAINAN CITY (TW)

(21) Appl. No.: 16/171,825

(22) Filed: Oct. 26, 2018

(51) Int. Cl. B29B 17/04; B29C 43/00; C08L 17/00

(52) U.S. Cl. CPC B29B 17/0404; B29C 43/006; B29L 2031/20; B29B 2017/042; C08L 17/00

(57) ABSTRACT

The invention relates to an environmentally friendly fuel made of rubber and a manufacturing method thereof. The manufacturing method comprises the steps of pulverizing a rubber material into rubber powder; and mixing the rubber powder with a toxin elimination material to eliminate deleterious compositions such as chlorine and sulfur, wherein the toxin elimination material comprises a non-halogen flame retardant and a desulfurizing agent.

### BACKGROUND OF THE INVENTION

### 1. Field of the Invention

The present invention relates to an environmentally friendly fuel made of rubber and a manufacturing method thereof which converts the discarded rubber materials into economical and environmentally friendly fuels.

### 2. Description of Related Art

Waste is divided into general waste and industrial waste. In order to avoid occupying land due to pile-up of large amount of waste, waste is usually incinerated, buried, or converted to renewable materials by other treatments to implement the concept of environmental protection and promote economic development. For instance, the Taiwan Patent Publication No. TW 1635134 (B), issued on 11 Sep. 2018, has disclosed an environmental fuel and a method for making the same, which uses waste plastic to make environmentally friendly fuel.

Waste rubber mainly comes from the rubber, defective products, waste materials produced by the tire manufacturing industry and the rubber factory in the process, as well as from waste tires generated by motor vehicle consumption.

Since there are tens of millions of vehicles driving all over the world, considerable waste tires are produced every year, which also causes environmental pollution. Generally, the composition of a tire is complicate, including natural and synthetic rubber, black carbon, nylon coils, steel wire, sulfur, petroleum, resin and the like. Therefore, after a plurality of materials are mixed in the tire manufacturing process and molded at a high temperature, the characteristics of the materials are substantially changed and cannot be restored to the original materials. Moreover, the calorific value (37 million joules per kilogram) of the waste tire is high. Although the waste tires were often cut or processed for use in cement kilns, power plants, and paper mill fuels in the past, the exhaust gas emitted during the processing contains suspended particles, e.g. carcinogenic dioxin and nitrogen oxides, and the slag also has a large amount of ash. Therefore, it usually cause air pollution and the overall resource utilization efficiency of the waste tire is still limited.

Additionally, some manufacturers treat waste tires, plastics and rubber in a cleavage manner to refine raw materials. In the cleavage process, carbon black rich in carbon is also accompanied. Although the carbon black can be used as coal, the cost of carbon black cleavage treatment is high. Accordingly, the cleavage treatment is not an economic way to reuse the carbon black.

### SUMMARY OF THE INVENTION

In view of the above-mentioned problems, the object of the present invention is to provide an environmentally friendly fuel made of rubber and a manufacturing method thereof which converts the discarded rubber materials into economical and environmentally friendly fuels.

The environmentally friendly fuel made of rubber comprises:

a rubber material added with 5-35% by weight of a toxin elimination material relative to the weight percentage of the rubber material, wherein the toxin elimination material comprises a non-halogen flame retardant and a desulfurizing agent at a ratio of 30-50%:50-70% so as to eliminate deleterious compositions such as chlorine and sulfur. Accordingly, a flammable and non-toxic environmentally friendly fuel of is provided, which also makes the discarded rubber materials recycle and use again.

According to an embodiment of the present invention, the environmentally friendly fuel made of rubber is a solid-form environmentally friendly fuel shaped by heating and pressuring.

The manufacturing method of an environmentally friendly fuel made of rubber, comprises the steps of:

(a) pulverizing a rubber material into rubber powder;

(b) mixing the rubber powder with a specific weight percentage (preferably 5-35% by weight) of a toxin elimination material relative to the weight percentage of the rubber material to form a mixed material, wherein the toxin elimination material consists of a non-halogen flame retardant and a desulfurizing agent at a ratio of 30-50%:50-70%;

(c) shaping the mixed material by heating and pressuring in a molding equipment to form a modeling;

(d) putting the modeling into a granulation device and heating it to inject the environmentally friendly fuel made of rubber; and

(e) cutting the environmentally friendly fuel made of rubber into a required size.

### BRIEF DESCRIPTION OF THE DRAWINGS

FIG. 1 is a schematic diagram showing an environmentally friendly fuel according to the present invention;

FIG. 2 is a flow chart showing a manufacturing method of an environmentally friendly fuel according to the present invention;

FIG. 3 is a schematic diagram showing an environmentally friendly fuel shaped as a round rod according to the present invention;

FIG. 4 is a schematic diagram showing an environmentally friendly fuel shaped as a rectangular column according to the present invention;

FIG. 5 is a schematic diagram showing an environmentally friendly fuel shaped as flakes according to the present invention.

### DETAILED DESCRIPTION OF THE PREFERRED EMBODIMENT

Hereinafter, an exemplary embodiment of the present invention will be described in detail with reference to the accompanying drawings.

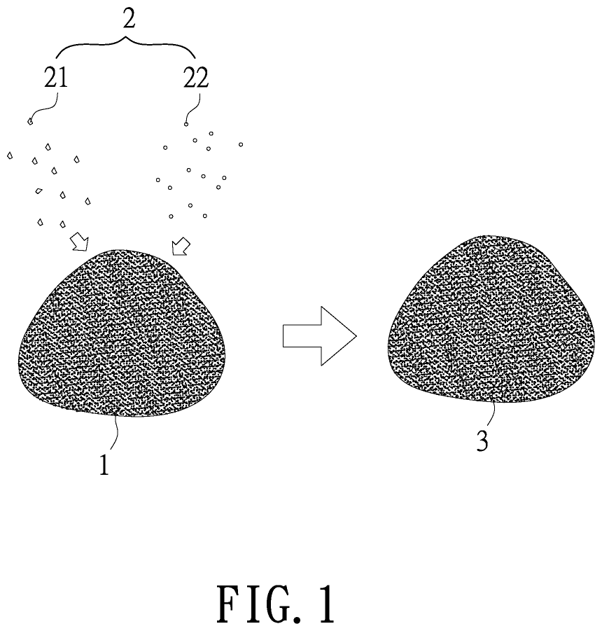

As showed in FIG. 1, schematic diagram showing an environmentally friendly fuel according to the present invention is disclosed herein. The environmentally friendly fuel (3) comprises a rubber material (1) added with a specific weight percentage a toxin elimination material (2) relative to the weight percentage of the rubber material (1) for full mixing. The toxin elimination material (2) comprises a non-halogen flame retardant (21) and a desulfurizing agent (22) at a specific ratio so as to eliminate deleterious compositions such as chlorine and sulfur. Accordingly, the environmentally friendly fuel (3) that is combustible and non-toxic is available.

The burning value of a general rubber material is high (about 7900 kal/kg), which may damage a boiler and produce harmful chlorine substances. After the toxin elimination material (2) comprising the non-halogen flame retardant (21) and the desulfurizing agent (22) is added into the rubber material (1) at a specific weight percentage, the non-halogen flame retardant (21) can reduce the combination of the rubber material (1) and external gas during combustion, so the burning value of the rubber material (1) is controlled at about 6000-6800 kal/kg, thereby reducing the generation of harmful chlorine substances. The desulfurizing agent (22) is mainly added to remove the sulfur in the waste rubber molecule by chemical reaction, and then the sulfur is captured by other substances to precipitate into a non-flammable and non-polluting substance, so that the rubber material (1) becomes the environmentally friendly fuel that has high quality and does not release sulfur oxides.

An embodiment of the desulfurizing agent is as follows. The reaction of 1, 4-benzoquinone and benzoic acid produces phenyl radical to undergo a phenyl radical reaction so as to further remove sulfur molecules from the rubber molecules, and then calcium-based materials, e.g. CaO, CaCO₃, CaC and the like are used to capture sulfur molecules to form harmless and non-flammable precipitates, e.g. CaS, CaSO₄ and the like.

It is worth mentioning that the flame retardant is a substance that can reduce flammability or slow the combustion of fuel. The flame retardant has been used in various field in life, e.g. transportation, electronics, electrical appliances, furniture, building materials and the like for a long time. The flame retardants have their intended use or field. Namely, the flame retardant is not versatile, and a particular flame retardant is typically selected depending on the desired application. The non-halogen flame retardant adopted in the present invention is suitable for a plastic material product, which is non-volatile and does not generate corrosive gas when burned, so it is also called a pollution-free flame retardant.

However, if the proportion of the non-halogen flame retardant (21) in the rubber material (1) is too high, the rubber material (1) cannot be burned, and therefore, the addition ratio must be appropriately controlled. The invention obtains the best addition ratio through experiments. Preferably, the rubber material (1) is added with 5-35% by weight of the toxin elimination material (2) relative to the weight percentage of the rubber material (1). The non-halogen flame retardant (21) and the desulfurizing agent (22) of the toxin elimination material (2) are mixed at a ratio of 30-50%:50-70%. The non-halogen flame retardant (21) is quantitatively between 1.5 to 17.5% by weight, and the desulfurizing agent (22) is quantitatively between 2.5 to 24.50% by weight, respectively relative to the rubber material (1). Furthermore, the environmentally friendly fuel is shaped by heating and pressuring to form a solid-form environmentally friendly fuel. When the rubber materials are not adhered to each other, the toxin elimination material is added into the pulverized rubber material, and an adhesive (e.g. an aqueous resin) of 2 to 6% by weight can be added. After the rubber materials are heated, pressurized, and molded, the solid-form environmentally friendly fuel that can be burned without toxicity is obtained.

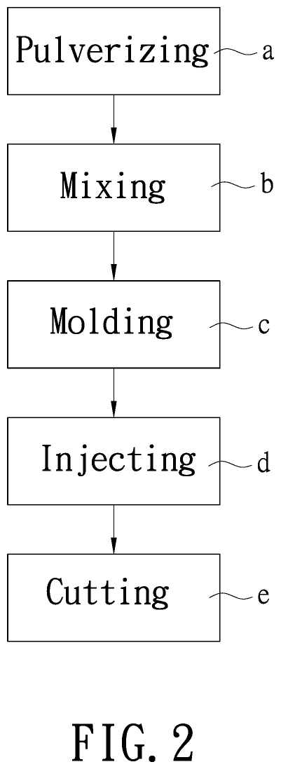

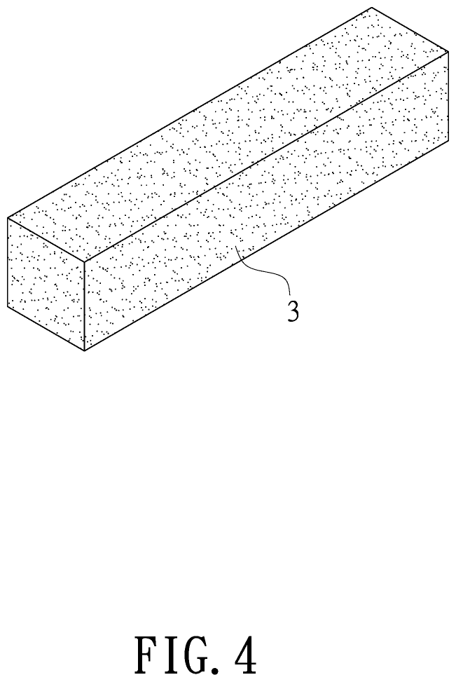

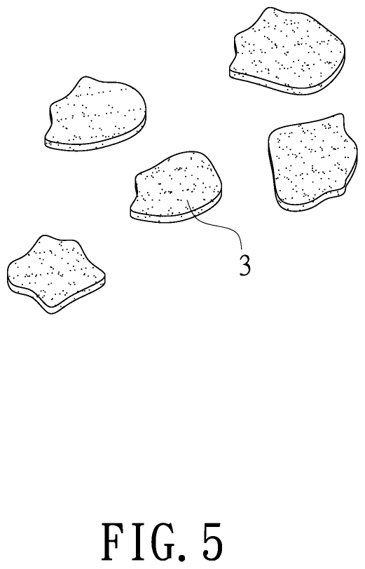

Referring to FIG. 2 to FIG. 5, the manufacturing method of an environmentally friendly fuel made of rubber comprises the steps of:

(a) pulverizing a rubber material (1) into rubber powder;

(b) mixing the rubber powder (1) with 5-35% by weight of a toxin elimination material (2) relative to the weight percentage of the rubber material (1) to form a mixed material, wherein the toxin elimination material (2) consists of a non-halogen flame retardant (21) and a desulfurizing agent (22);

(c) shaping the mixed material by heating and pressuring to form a modeling;

(d) putting the modeling into a granulation device and heating it to inject the environmentally friendly fuel made of rubber (3); and

(e) cutting the environmentally friendly fuel made of rubber (3) into a required size.

As shown in FIG. 2, a pulverizing step (a) is first conducted. The the rubber powder (1) is placed in a grinding device, such as a chamfering machine, a disintegrator and the like. Preferably, the rubber powder (1) is pulverized into rubber powder. For step (b), the rubber powder is placed in a stirring device for mixing with a specific weight percentage of the toxin elimination material (2). Preferably, the weight percentage of the toxin elimination material (2) added to the rubber material (1) is 5-35% relative to the weight percentage of the rubber material. The ratio of the non-halogen flame retardant (21) and the desulfurizing agent (22) is controlled at 30-50%:50-70%. The non-halogen flame retardant (21) is quantitatively between 1.5 to 17.5% by weight, and the desulfurizing agent (22) is quantitatively between 2.5 to 24.50% by weight, respectively relative to the rubber material (1). After thorough mixing by the stirring device (e.g. ball mixing machine), the obtained mixed material can be used as the powdery environmentally friendly fuel (3).

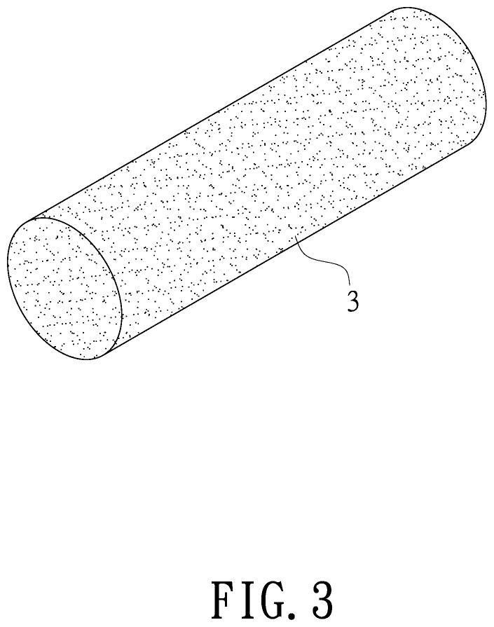

For preparing the solid-form environmentally friendly fuel (3), the mixed material is placed in a molding machine, e.g. a double drum machine or a kneader for heating and pressuring so that the mixed material is shaped to form a modeling having high density in step (c). Then, in step (d), the modeling is placed into the granulation device for heating and injecting the environmentally friendly fuel with a variety of shapes, e.g. sphere, round rod, rectangular column, sheet (flake), grain and the like as shown in FIG. 3 to FIG. 5. Finally, the environmentally friendly fuel (3) is cut into a required size in step (e) to make the environmentally friendly fuel (3) suitable for combustion.

In order to increase the density of the modeling and inject the environmentally friendly fuel (3) with better forming effect, the adhesive of 2 to 6% by weight can be added into the modeling before the modeling is placed into the granulation device and heating in step (d). The adhesive is preferably an aqueous resin. Therefore, the solid-form environmentally friendly fuel (3) is shaped without loosening.

Compared with the technique available now, the present invention has the following advantages:

1. The present invention added with the non-halogen flame retardant to the rubber material effectively inhibits the generation of toxic chlorine gas and chlorine substance during combustion.

2. The present invention added with the desulfurizing agent to the rubber material effectively removes the sulfur in the waste rubber molecule by chemical reaction and makes the sulfur further captured by other substances to precipitate into a non-flammable and non-polluting substance, so that the rubber material becomes the environmentally friendly fuel that has high quality and does not release sulfur oxides.

3. The present invention added with the flame retardant to the rubber material effectively reduces the combination of the rubber material and external gas during combustion, so the burning value of the rubber material is decreased, thereby reducing the generation of harmful chlorine substances and achieving the effect of non-toxic combustion.

4. The present invention added with the adhesive has not only increased density and improved forming effect but also improved adhesion.

What is claimed is:

1. An environmentally friendly fuel made of rubber, comprising:
a rubber material added with 5-35% by weight of a toxin elimination material relative to the weight percentage of the rubber material, wherein the toxin elimination material comprises a non-halogen flame retardant and a desulfurizing agent at a ratio of 30-50%:50-70%.

2. The environmentally friendly fuel made of rubber as claimed in claim 1, is a solid-form environmentally friendly fuel shaped by heating and pressuring.

3. A manufacturing method of an environmentally friendly fuel made of rubber, comprising the steps of:
(a) pulverizing a rubber material into rubber powder; and
(b) mixing the rubber powder with 5-35% by weight of a toxin elimination material relative to the weight percentage of the rubber material so as to form the environmentally friendly fuel made of rubber, wherein the toxin elimination material consists of a non-halogen flame retardant and a desulfurizing agent.

4. The manufacturing method of an environmentally friendly fuel made of rubber as claimed in claim 3, wherein the non-halogen flame retardant and the desulfurizing agent are at a ratio of 30-50%:50-70%.

5. A manufacturing method of an environmentally friendly fuel made of rubber, comprising the steps of:
(a) pulverizing a rubber material into rubber powder;
(b) mixing the rubber powder with 5-35% by weight of a toxin elimination material relative to the weight percentage of the rubber material to form a mixed material, wherein the toxin elimination material consists of a non-halogen flame retardant and a desulfurizing agent;
(c) shaping the mixed material by heating and pressuring to form a modeling;
(d) putting the modeling into a granulation device and heating it to inject the environmentally friendly fuel made of rubber; and
(e) cutting the environmentally friendly fuel made of rubber into a required size.

6. The manufacturing method of an environmentally friendly fuel made of rubber as claimed in claim 5, wherein the non-halogen flame retardant and the desulfurizing agent are at a ratio of 30-50%:50-70%.
